(19) United States
(12) Patent Application Publication
(10) Pub. No.: US 2025/0245599 A1
(43) Pub. Date: Jul. 31, 2025

(54) PRODUCT RESILIENCY AND HEALTH ASSESSMENT

(71) Applicant: Wells Fargo Bank, N.A., San Francisco, CA (US)

(72) Inventors: Goutam Gandhi, Glen Allen, VA (US); Scott Mitchell Meltzer, Glen Rock, NJ (US); Debjani Saha, Glen Allen, VA (US)

(21) Appl. No.: 17/936,707

(22) Filed: Sep. 29, 2022

(51) Int. Cl. G06Q 10/0639

(52) U.S. Cl. CPC G06Q 10/06393

(57) ABSTRACT

With the increasing reliance on digitization, evolving business models, and increasing regulatory and compliance requirements, organizations face new and unknown operational risks An example product resiliency and health assessment system provides product-level risk identification, resiliency and health reporting by automatically retrieving and assessing multi-dimensional data, creating a health scorecard to convey discrete measurement of the health of the overall product and the sub-components of the product, and providing actionable remediation plans for identified weaknesses.

### BACKGROUND

Business organizations include different products that are used to conduct business. Organizations are constantly evolving and trying new business models and complex value chains and pursuing increasing digitization with their different products and services. With such pursuits also come new and unknown operational risks.

### SUMMARY

Embodiments of the disclosure are directed to a product resiliency and health assessment system that assesses the health of one or more products of an organization.

In a first embodiment, a method to assess a health of a product is disclosed. The method comprises: receiving one or more applications associated with the product, wherein to assess the health of the product, each of the one or more applications is assessed based on multiple dimensions; retrieving data related to the multiple dimensions associated with each of the one or more applications from one or more data sources; retrieving one or more assessment criteria to assess each of the multiple dimensions associated with each of the one or more applications; providing responses to each of the one or more assessment criteria based on the retrieved data; assigning scores to the responses to each of the one or more assessment criteria; based on the assigned scores, calculating an overall health score for the product; and generating a user interface for display on a user electronic computing device, wherein the user interface includes the overall health score with one or more visual elements to denote a level of health indicated by the overall health score.

In a second embodiment, a product health assessment system is disclosed. The system comprises: a processor; and memory comprising instructions that when executed by the processor causes the processor to: receive one or more applications associated with the product, wherein to assess the health of the product, each of the one or more applications is assessed based on multiple dimensions; retrieve data related to the multiple dimensions associated with each of the one or more applications from one or more data sources; retrieve one or more assessment criteria to assess each of the multiple dimensions associated with each of the one or more applications; provide responses to each of the one or more assessment criteria based on the retrieved data; assign scores to the responses to each of the one or more assessment criteria; based on the assigned scores, calculate an overall health score for the product; and generate a user interface for display on a user electronic computing device, wherein the user interface includes the overall health score with one or more visual elements to denote a level of health indicated by the overall health score.

In a third embodiment, a method to assess a health of a product is disclosed. The method comprises: receiving one or more applications associated with the product; retrieving data related to multiple dimensions associated with each of the one or more applications from one or more data sources; retrieving one or more assessment criteria to assess each of the multiple dimensions associated with each of the one or more applications; providing responses to each of the one or more assessment criteria based on the retrieved data; assigning scores to the responses to each of the one or more assessment criteria; based on the assigned scores, calculating an overall health score for the product by: calculating a dimension-level score for each of the multiple dimensions of each of the one or more applications by averaging the assigned scores associated with the one or more assessment criteria for each of the multiple dimensions; calculating an application-level score for each of the one or more applications associated with the product by averaging the dimension-level score associated with each of the multiple dimensions associated with each of the one or more applications; and calculating the overall health score by calculating a weighted average score based on the assigned weights of the each of the one or more applications and the application-level score of each of the one or more applications; and generating a user interface for display on a user electronic computing device, wherein the user interface includes the overall health score of the product, the application-level score for each of the one or more applications associated with the product, and the dimension-level score for each of the multiple dimensions of each of the one or more applications; and wherein the overall health score, the application-level score and the dimension-level score are color coded to visually indicate a level of health.

The details of one or more techniques are set forth in the accompanying drawings and the description below. Other features, objects, and advantages of these techniques will be apparent from the description, drawings, and claims.

### BRIEF DESCRIPTION OF DRAWINGS

The following drawings are illustrative of particular embodiments of the present disclosure and therefore do not limit the scope of the present disclosure. The drawings are not to scale and are intended for use in conjunction with the explanations in the following detailed description. Embodiments of the present disclosure will hereinafter be described in conjunction with the appended drawings, wherein like numerals denote like elements.

FIG. 1 illustrates an example configuration of a product resiliency and health assessment system.

FIG. 2 illustrates an example configuration of a product resiliency and health assessment engine of the product resiliency and health assessment system of FIG. 1.

FIG. 3 illustrates an example process executed by the product resiliency and health assessment engine of FIG. 2 to assess the health and resiliency of a product.

FIG. 4 illustrates an example user interface display generated by the product resiliency and health assessment engine of FIG. 2.

FIG. 5 illustrates another example user interface display generated by the product resiliency and health assessment engine of FIG. 2.

FIG. 6 illustrates yet another example user interface display generated by the product resiliency and health assessment engine of FIG. 2.

FIG. 7 illustrates example physical components of the computing devices of FIG. 1.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

Business organizations may include different products and services that are used to conduct business. For example, financial institutions may include products such as online banking, wire transfers, automated teller machines, trading platforms, etc. With the increasing reliance on digitization, evolving business models, and increasing regulatory and compliance requirements, organizations face new and unknown operational risks. Incidents of customer/client impacts and failed customer interactions due to such operational risks are rising. Thus, organizations have a need for product-level risk identification, resiliency and health reporting.

The disclosed product resiliency and health assessment system retrieves multi-dimensional data to assess the resiliency and health of products and services offered by an organization. The disclosed product resiliency and health assessment system may also calculate a health scorecard that defines stability, reliability, availability, and resiliency metrics and provide actionable remediation plans for identified weaknesses.

The disclosed product resiliency and health assessment system may be used to select one or more products or applications for assessment. Upon selection of one or more products, the disclosed product resiliency and health assessment system may be used to collect data related to the selected one or more products from one or more internal or external data sources. After the collection of data, the product resiliency and health assessment system may assess and score the collected data based on one or more competency metrics.

Based on the assessments the product resiliency and health assessment system may score the one or more products across the multiple dimensions and generate a summary of the assessment, application-level and/or overall product-level scorecards quantifying the resiliency and health of the product, and recommendations to improve the scores on the scorecards. The disclosed product resiliency and health assessment system may display the results of the assessment on a user interface display. For example, the resiliency and health assessment results may be displayed as a numerical score with one or more visual elements to convey the level of health of the products.

By regularly and automatically performing the health assessment and calculating discrete scores for the overall product, as well as the sub-components of the product, across multiple dimensions and competency metrics, the disclosed product resiliency and health assessment system increases the efficiency of the computing system. For example, without the disclosed product resiliency and health assessment system, organizations may not realize risks associated with certain components of one or more of the organization's products until the organization encounters an issue, which takes large amounts of computing resources to fix or otherwise remedy.

In addition, the use of discrete scores along with one or more visual elements, such as the use of color coding and different indicators, creates a user interface display that efficiently conveys the health of the product and sub-components across multiple dimensions and competency metrics. Such a user interface display allows for the user to quickly understand the deficiencies and strengths associated with product without having to run separate tools, read through reports or navigate through many screens to understand the level of health of the products of the organization.

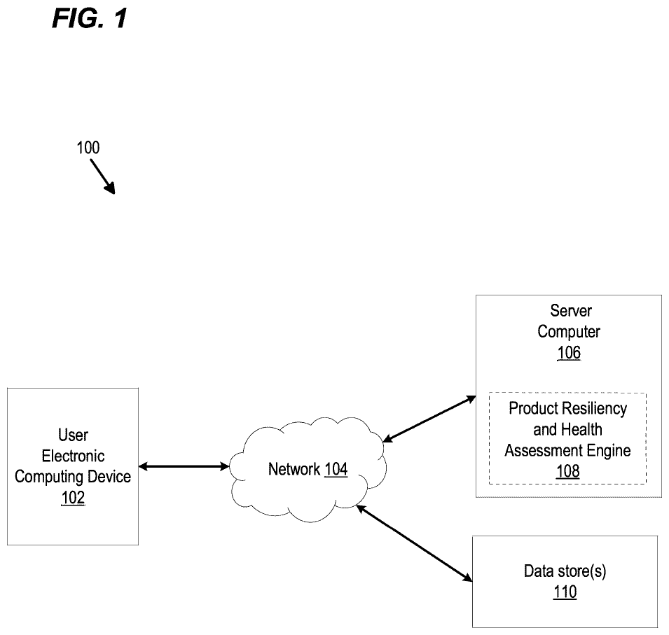

FIG. 1 illustrates an example configuration of a product resiliency and health assessment system 100. The product resiliency and health assessment system 100 includes a user electronic computing device 102, a network 104, a server computer 106 and one or more data stores 110. In some examples, the server computer 106 may include a product resiliency and health assessment engine 108. More, fewer, or different modules can be used.

In some examples, user electronic computing device 102 is an electronic computing device of the user. In some examples, the electronic computing device can be a desktop computer, a laptop computer, virtual reality user device, a mobile electronic computing device such as a smartphone or a tablet computer. The electronic computing device permits the user to access the server computer 106 over a network 104.

In some examples, the user may be an individual or an organization that is interested in assessing the resiliency and health of one or more products of the organization. For example, the organization may be a financial institution. Other types of organizations engaged in other types of businesses or services is also possible Although a single user electronic computing device 102 is shown, the system 100 allows hundreds, thousands, or more computing devices to connect to the server computer 106.

In some examples, the network 104 is a computer network, such as the Internet. The user electronic computing device 102 can access the server computer 106 via the network 104.

In a preferred example, the server computer 106 is a server computer of a financial institution, such as a bank or a server computer of an entity providing service related to one or more financial products. Although a single server is shown, in reality, the server computer 106 can be implemented with multiple computing devices, such as a server farm or through cloud computing. Many other configurations are possible.

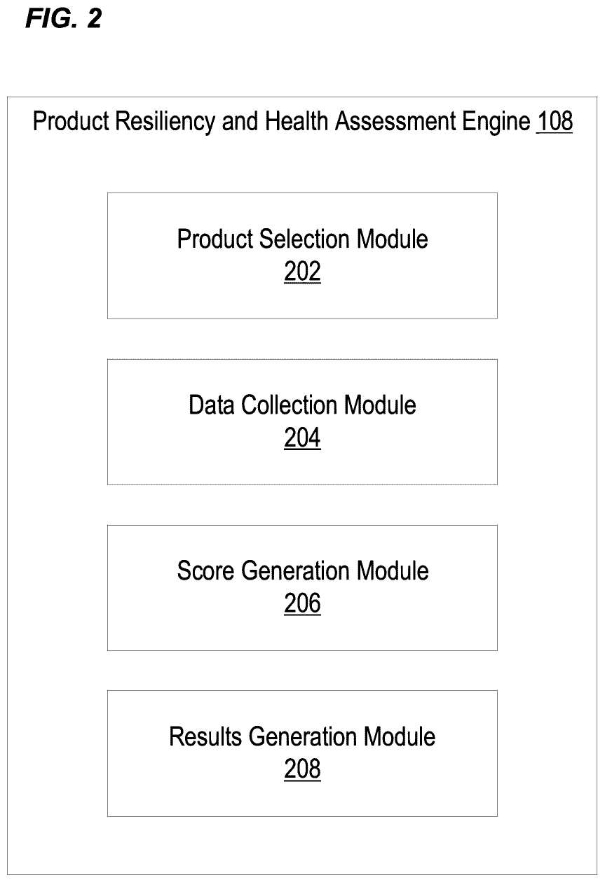

In one example, the product resiliency and health assessment engine 108 is configured to receive collect data, assess and score the product based on competency metrics and provide recommendations regarding how to improve the scores. The implementation of the product resiliency and health assessment engine 108 is described in further detail in relation to FIG. 2.

The example data store 110 may include one or more electronic databases that can store data related to the product resiliency and health assessment engine 108. The data store 110 may be maintained by the same entity that maintains the server computer 106 or one or more external enterprises associated with the entity that maintains the server computer 106. The data store 110 can be accessed by server computer 106 to retrieve relevant data associated with the product resiliency and health assessment engine 108.

FIG. 2 illustrates an example configuration of the product resiliency and health assessment engine 108 of FIG. 1. In some examples, the product resiliency and health assessment engine 108 may be configured to include a product selection module 202, a data collection module 204, a score generation module 206 and a results generation module 208. In other examples, the product resiliency and health assessment engine 108 may be configured different and may include more or fewer modules.

The product selection module 202 of the product resiliency and health assessment engine 108 may be configured to select one or more products of the entity or organization for assessment. In some examples, the product resiliency and health assessment engine 108 may receive a user selection of one or more of the one or more products of the organization for resiliency and health assessment. In other examples, the product resiliency and health assessment engine 108 may automatically select one or more products for assessment.

In examples where the one or more products are selected manually, the selection of the one or more products for assessment may be made via a user interface display generated by the product resiliency and health assessment engine 108 and displayed on the user electronic computing device 102. The user interface display may include user selectable options that include the one or more products associated with the organization. A user, via the user interface display displayed on the user electronic computing device 102, may select one or more of the one or more products for assessment.

The automatic selection of the one or more products may depend on the needs of the organization. For example, a product may be automatically chosen for assessment based on one or more factors, including, but not limited to: the level of importance of the product to the organization, whether the product is customer facing, whether the product has historically had health and/or resiliency issues, the level of impact a compromise to the product would have to the organization, and whether the product is on the cusp of getting released.

Although the product selection module 202 is described in terms of selection of one or more products, each of the one or more products may include one or more applications. In some examples, upon selection of a product for assessment, all applications associated with the product may be assessed. However, in other examples the product selection module 202 may also be used to only select a subset of the applications associated with one or more products for assessment.

Upon selection of one or more products, the data collection module 204 of product resiliency and health assessment engine 108 may be used to collect multi-dimensional data related to the selected one or more products from one or more internal or external data sources, including data related to each of the applications associated with each of the one or more selected products. In some examples, the user may even supplement the collected data by manually entering relevant data related to the one or more selected products or one or more applications associated with the one or more selected products. The data collection module 204 may also be configured to store the collected data in one or more data stores, including data store 110. The types of data that are collected may be informed by the types of assessments conducted by the score generation module 206, described below in further detail.

After the collection of data by the data collection module 204, the score generation module 206 of the product resiliency and health assessment engine 108 may assess and score the collected data. The score generation module 206 may retrieve the collected data from the one or more data stores and conduct an analysis of the collected data across multiple dimensions to assess the data based on one or more competency metrics. The one or more competency metrics may include, but are not limited to: stability, resiliency, availability and reliability.

For example, the multiple dimensions include different facets of an application or product that indicate the health of a product. In some examples, the multiple dimensions across which collected data may be assessed may include one or more of: data resiliency, security assessment, technology debt, operations performance, business process, failover and technology governance and compliance. Processing and assessment of data across more of fewer dimensions is also possible.

For example, data resiliency relates to data processes and controls, recovery capability and protection strategy associated with product data. Security assessment relates to secure coding practices and identifies risks, defects, past due defects associated with the underlying codes used to build the selected product. Technology debt relates to end-of-life or depreciated assets that pose risks to the product and/or organization. For example, a thorough server analysis may identify non-compliant software and hardware information, past due compliance events, past due and critical vulnerabilities.

Operation performance relates to identification of incident tickets. Incident tickets may be used to identify pattern of issues, risks, ticket volumes, noise in tickets, quality of tickets, and customer and financial impacts caused due to the incident. Business process relates to identifying whether the product architecture follows best practices, reviews by boards, appropriate documentation and diagraming procedures, and appropriate performance criteria processes.

Failover is related to identifying if the product has appropriate protocols to switch to a standby databases, servers or networks in case of system failures. Technology governance and compliance relates to identifying whether the product is in compliance with regulatory protocols, includes appropriate consent orders, service level agreements and business process controls.

As described above, the score generation module 206 may evaluate the collected data associated with the selected applications and products across each of the multiple dimensions based on the competency metrics in order to generate a scores of different granularity to denote the resiliency and health of the applications and products.

For example, for each product that is selected for assessment, the score generation module 206 first obtains a list of applications that are associated with the product. The score generation module 206 may retrieve the information regarding the product and the associated applications from data store 110. Once the list of applications associated with each of the selected products is obtained, the score generation module 206 may assign weights to each of the applications on the list based on a variety of criticality factors including, but not limited to: the level of importance of the product to the organization, whether the product is customer facing, whether the product has historically had health and/or resiliency issues, the level of impact a compromise to the product would have to the organization, and whether the product is on the cusp of getting released.

In some examples, the weights may be numerical and may range between 1 and 5, with 1 being the lowest weight and 5 being the highest weight. The most critical or important application that better predict the overall health of the product may receive a weight of 5, while applications that are not critical in evaluating the health and resiliency of the product may receive a weight of 1. A similar weighting system may also be used to assign weights to the one or more products within the organization.

The score generation module 206 may retrieve a list of assessment criteria and scoring metrics associated with each of the dimensions and competency metrics from the data store 110. For example, as described above, each application within a selected product may be evaluated based on competency criteria across multiple dimensions. For each dimension, a list of assessment criteria and scoring metrics may be used to aid in the evaluation of the application across each of competency criteria.

The assessment criteria may include a list of questions or a survey. The scoring metrics may provide rules on how to assign scores based on the response to the list of questions or the survey. The score generation module 206 may automatically retrieve responses to the assessment criteria based on the data collected and stored in the data store 110 by the data collection module 204. In some examples, the score generation module 206 may also request supplemental responses to be entered manually by the user via a user interface display on the user electronic computing device 102. In one example, a response that fully meets the assessment criteria may receive a score of 4, a response that partially meets the assessment criteria may receive a score of 3 and a response that does not meet the assessment criteria may receive a score of 1.

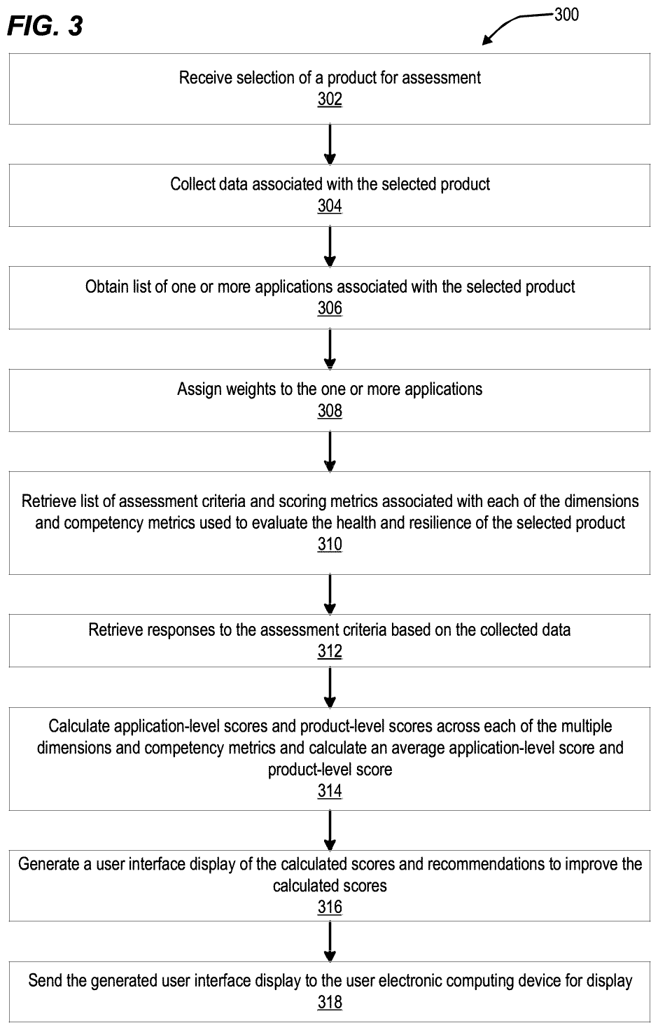

Once all applications of each of the selected products are assigned scores for each of the competency metrics across each of the multiple dimensions, the scoring metrics may be used to calculate application-level scores and product level scores based on the assigned scores and assigned weights. The scoring process is described in further detail in relation to FIG. 3.

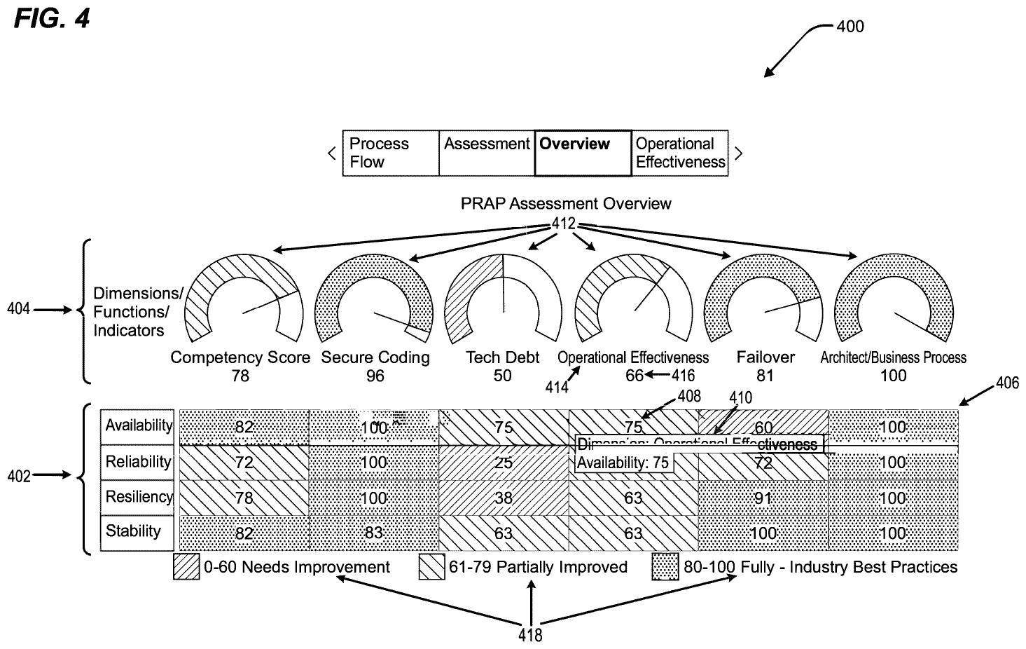

Based on the assessments and calculated scores from the score generation module 206, the results generation module 208 of the product resiliency and health assessment engine 108 may create application and/or product level scorecards based on the generated scores and display the scorecard on a dynamic user interface display. The user interface display may be generated to include visual elements that convey the resiliency and health status of the product to the user efficiently. The user interface displays generated by the results generation module 208 are described in further detail in relation to FIGS. 4-6.

In addition to the generation of the scorecard, the results generation module 208 may also generate and display an executive summary of the assessment, key findings from the assessment along with actionable recommendations to increase the scores associated with one or more of the dimensions, product business flow diagrams with critical paths. The recommendations may be based on the responses to the assessment criteria. For example, when responses to assessment criteria do not fully meet the assessment criteria, the results generation module 208 may generate a recommendation that the particular assessment criteria may need improvement.

The product resiliency and health assessment engine 108 may store the results from the assessment, including the score cards for comparison to future assessments. For example, the product resiliency and health assessment engine 108 may automatically or through a manual prompt re-run assessments periodically to track the resiliency and health of the products of the organization over a period of time. Thus, an organization can track progress in making products more resilient and healthier over periods of time and evaluate whether efforts to improve scores are successful and how to maintain or change improvement strategies.

FIG. 3 illustrates an example process 300 executed by the product resiliency and health assessment engine to assess the health and resiliency of a product.

In example operation 302, the product selection module 202 of the product resiliency and health assessment engine 108 receives a selection of a product for assessment. Although the product selection module 202 may receive automatic or manual selections of one or more products for assessment, the example process 300 described in FIG. 3 will focus on the assessment of one of the selected product(s). A similar process may be used to assess each of the selected products(s).

In example operation 304, the data collection module 204 of the product resiliency and health assessment engine 108 collects data relevant to the selected product from operation 302 from one or more data sources internal and external to the organization. The collected data may be stored in data store 110 for later use in completing the resiliency and health assessment of the selected product. The data collected by the data collection module 204 include data that are relevant to the assessment criteria used to makes assessments and generate assessment scores across the multiple dimensions and competency criteria.

For example, an assessment criteria to evaluate the reliability competency criteria of the operational effectiveness dimension of the selected product may include an assessment of what volume of problem tickets are reported year-to-date. The data collection module 204 of the product resiliency and health assessment engine 108 may collect data related to problem tickets that are logged within the information technology databases of the organization. The assessment criteria, data needed to respond to the assessment criteria questions and score calculation methodology are further described below in relation to operations 310-314.

In example operation 306, the score generation module 206 of the product resiliency and health assessment engine 108 may obtain a list of one or more application associated with the selected product. For example, the score generation module 206, as an initial step of the assessment process, may retrieve information related to the selected product, including a list of one or more applications that the product encompasses.

In example operation 308, the score generation module 206 of the product resiliency and health assessment engine 108 may assign weights to the one or more applications associated with the selected product. For example, the one or more applications encompassed by the selected product may not all be equally critical or important in predicting the resiliency and health status of the selected product. In order to calculate a product score that accurately predicts the resiliency and health of the selected product, the one or more applications are weighted based on one or more criticality factors, including, but not limited to: the level of importance of the product to the organization, whether the product is customer facing, whether the product has historically had health and/or resiliency issues, the level of impact a compromise to the product would have to the organization, and whether the product is on the cusp of getting released.

In some examples, the weights may be numerical and may range between 1 and 5, with 1 being the lowest weight and 5 being the highest weight. Other ways of weighting the applications are also possible. The most critical or important application may receive a weight of 5, while applications that are not critical in evaluating the health and resiliency of the product may receive a weight of 1.

In example operation 310, the score generation module 206 of the product resiliency and health assessment engine 108 may retrieve a list of assessment criteria and scoring metrics associated with each of the dimensions and competency metrics used to evaluate the resilience and health of each of the applications encompassed under the selected product. For example, the assessment criteria and scoring metric may be retrieved by the score generation module 206 from data store 110.

For example, as described above, each application within the selected product may be evaluated based on competency criteria across multiple dimensions. For each dimension, a list of assessment criteria and scoring metrics may be used to aid in the evaluation of the application across each of competency criteria. The assessment criteria may include a list of questions or a survey. The scoring metrics may provide rules on how to assign scores based on the response to the list of questions or the survey.

In some examples, for each dimension, such as data resiliency, security assessment, technology debt, operations performance, business process and failover, assessment criteria may include a list of questions under each of the competency criteria (availability, reliability, resiliency and stability). For example, for the operational effectiveness dimension, the assessment criteria for the availability competency may include questions such as, “what is the volume of change requests successfully implemented in the past year?,” “how many incidents missed the SLA?”, etc. For the operational effectiveness dimension, an example assessment criterion for the reliability competency may include questions such as, “what is the volume of problem tickets report year-to-date?” “how many sev 1, 2 incidents were reported in the past year?”, etc.

In example operation 312, the score generation module 206 of the product resiliency and health assessment engine 108 may retrieve responses to the assessment criteria questions based on the data collected and stored in the data store 110 by the data collection module 204 in operation 304. In some examples, the retrieval of responses to the assessment criteria questions is done automatically. For example, the score generation module 206 may analyze data collected and stored in operation 304 to retrieve information relevant to each assessment criteria in order to answer the question automatically.

In other examples, the score generation module 206 may not be able to answer the assessment criteria questions automatically using the collected information and may have to display the one or more of the questions on a user interface display on the user electronic computing device 102 for user to respond manually. Based on the received responses, each of the assessment criteria questions may be identified as being “fully compliant,” “partially compliant,” and “not compliant.”

The responses to the assessment criteria questions may inform the level to which the application complies with the competency criteria for each dimension. For example, the availability competency may include an assessment criterion question of “how many exception change requests were implemented in the past year?” The response to assessment criterion question, retrieved from the collected data, may indicate that there were 0 exception change requests implemented in the past year. Based on this response, the assessment criterion question may be identified as being fully compliant with the expectations of the availability competency and the question may be marked as being “fully compliant”.

On the other hand, the availability competency may include another assessment criterion question of, “how many emergency change requests were implemented in the past year?” The response to assessment criterion question, retrieved from the collected data, may indicate that there were 6 emergency change requests implemented in the past year. The score generation module 206 may, based on the assessment rules associated with the question, identify that the response to the assessment criterion only partially complies with the expectations of the availability competency and the question may be marked as being “partially compliant”.

The score generation module 206 may analyze and retrieve the relevant responses to each of the assessment criteria questions for each of the competency criteria for each dimension for each application. The level of compliance assessed from the responses to the assessment criteria questions for each competency criteria for each dimension may inform the assessment score for the competency criteria. The scoring process is described in further detail in relation to operations 314.

In example operation 314, the score generation module 206 of the product resiliency and health assessment engine 108 may calculate application-level scores and product-level score across each of the multiple dimensions and competency metrics and average application-level score and average product-level score.

For example, to calculate application-level scores across each of the multiple dimensions and competency metrics, the score generation module 206 assigns scores to each of assessment criteria questions based the responses from operation 312. To calculate the average application-level score, the average score of the application-level scores across each of the multiple dimensions and competency metrics may be calculated. To calculate project-level scores across each of the multiple dimensions and competency metrics, the weight-adjusted application-level scores across each of the multiple dimensions and competency metrics may be used. To calculate the average project-level score, the weight adjusted average application-level scores may be used.

The score generation module 206 may assign scores to each of assessment criteria questions based the responses from operation 312. When a response is determined to be “fully compliant,” the score generation module 206 may assign the assessment criteria questions a score of 4. When a response is determined to be “partially compliant,” the score generation module 206 may assign the assessment criteria questions a score of 3. When a response is determined to be “not compliant,” the score generation module 206 may assign the assessment criteria questions a score of 1. Other ways of scoring the assessment criteria questions is also possible.

Each dimension associated with the application, as described above, may be assessed across competency metrics such as availability, reliability, resiliency, and stability. Each of the competency metrics for each of the dimensions of an application may include one or more assessment criteria questions.

To calculate the competency-level score for each of the competency criteria for each of the dimensions of the application, the scores assigned to each assessment criteria questions associated with the competency criteria may be averaged together. For example, if the operational effectiveness dimension of a first application of a product includes four questions under the “availability” competency criteria, the scores associated with each of the four questions can be averaged together and converted to a scale out of 100 and provided as the score for the “availability” competency criteria of the operational effectiveness dimension of the first application.

For example, if three out of the four questions were determined to be “fully compliant” and one question out of the four questions were determined to be “partially compliant,” then the four questions would be assigned scores of 4, 4, 4 and 3. The average of the four scores would be 3.75 out 4, which results in a scaled and rounded score of 94 out of 100 for the “availability” competency criteria of the operational effectiveness dimension of the first application. A similar process may be used to calculate scores for each competency criteria of each dimension for each application of the selected product.

The dimension-level score for each application may include averaging the of the competency criteria for each of the dimensions of the application. For example, when each dimension of an application includes four different competency criteria, the competency-level scores may be averaged together to determine the dimension-level score. For example, for an application with six different dimensions, wherein each dimension is assessed across the four competency criteria, the competency-level score for each of the four competency criteria may be averaged together to arrive at the dimension-level score.

For example, if the four competency-level scores for a first dimension of the first application include: 82, 72, 78, and 82, then the dimension-level score for the first dimension of the first application is calculated by averaging the four competency-level scores, which results in a dimension-level score of 78.

The application-level score may include averaging the dimension-level scores for each of the dimensions associated with the application. For example, for an application with six different dimensions, the dimension-level score across each of the six different dimensions may be averaged together to arrive at the application-level score. For example, if the six dimension-level scores of the first application include: 78, 96, 50, 66, 81, and 100, then the application-level score for the first application is calculated by averaging the six dimension-level scores, which results in an application-level score of 78.

The product-level score may be calculated by weight-adjusting the application level scores. For example, the application-level scores may be weight adjusted by applying the application weights determined in operation 308. The weighted average may be calculated by dividing the sum of the weighted application scores by the total weights. For example, for a product that includes three applications, a first application with a weight of 4 and a application-level score of 82, a second application with a weight of 2 and an application-level score of 67 and a third application with a weight of 3 and an application-level score of 93, the weighted, rounded average product-level score may be calculated as follows: (4*82+2*67+3*93)/(4+2+3)=82.

A similar process may be used to calculate product-level scores for specific dimensions or competency criteria. For example, to calculate the product-level average dimension score for a particular dimension, the dimension-level score for each of the applications encompassed within the product may be multiplied by the application weights and divided by the total weights across the applications.

In example operation 316, the results generation module 208 of the product resiliency and health assessment engine 108 may generate a user interface display of the calculated scores and one or more recommendations to improve the calculated scores. For example, the results generation module 208 may generate a user interface display that includes one or more scorecards that conveys the calculated scores using visual elements that makes it easier for the user to efficiently understand the resiliency and health of the applications and product at different levels of granularity.

The results generation module 208 may use color coding to instantly convey whether application meets industry best practices, partially meets best practices or needs improvements. For example, scores that range from 80-100 may be considered as fully meeting industry best practices standards and may be highlighted in green. Scores that range from 61-79 may be considered as partially meeting industry best practice standards and may be highlighted in yellow. Scores that range from 0-60 may be considered as needing improvement and may be highlighted in red. Other types of scoring and visual elements like colors may also be used to covey the health of the applications and products.

For example, the results generation module 208 may generate and display an executive summary regarding the assessment, including a summary of the resiliency and health of the product and the underlying applications. The results generation module 208 may present the assessment data using different user interface display elements, including a simple spider chart view that presents the dimension-level scores for each application, an actionable finding view that presents dimension-level scores for each of the applications, along with recommendations on how to improve the score before the next assessment and a product maturity scorecard that presents the dimensional-level and competency level scores for an application along with key observations and score changes over a period of time. Other types of information may also be presented in the user interface. Example user interface displays are described in greater detail in relation to FIGS. 4-6.

The results generation module 208 may also evaluate the list of assessment criteria questions for the competency-level scores and dimension-level scores that do not fully meet competency standards to automatically generate recommendations on the types of criteria that need to be improved in order to improve the generated scores. For example, if one of the assessment questions for the availability competency criteria was “how many emergency change requests were implemented in the past year?” and the response of “6” was considered to not fully comply with the industry best practice standards, the results generation module 208 may determine what response would result in a score that was “fully compliant.” For example, if the results generation module 208 determines that a response of 3 or lower would result in a score that was considered to be “fully compliant,” the results generation module 208 may generate a recommendation that says, “evaluate why emergency change request are implemented and reduce the number of requests to be 3 or less per year.” Other ways of automatically generating the recommendations for improving scores may also be possible.

In example operation 318, the results generation module 208 of the product resiliency and health assessment engine 108 may send the user interface display generated in operation 316 to the user electronic computing device 102 for display on the user electronic computing device 102.

FIG. 4 illustrates an example user interface display 400 generated by the product resiliency and health assessment engine of FIG. 2. The user interface display 400 is configured to display an overview of the assessment scores for an application.

For example, the user interface display 400 includes a competency criteria panel 402 and a dimensions panel 404. The competency criteria panel 402 includes a grid 406 that includes a row for each of the competency criteria. In the noted example from FIG. 4, the competency criteria include “availability,” “reliability,” “resiliency” and “stability.” Each of the columns of the grid 406 correspond to one of the dimensions detailed in relation to the dimensions panel 404. Each cell of the grid 406 includes a competency-level score 408 that is related to the competency criteria corresponding to the row of the cell and the dimension corresponding to the column of the cell.

The cells of the grid 406 may be color coded to indicate the level to which the particular competency complies with industry best practices and generally serves as an indicator of the health of the application. In addition, hovering over or selecting a cell of the grid 406 may cause the display of a pop-up display box 410 that includes the name of the dimension corresponding to the cell, the name of the competency criteria corresponding to the cell and the competency-level score associated with the cell.

The dimensions panel 404 includes dial indicators 412 for each of the multiple dimensions associated with the application for which the overview of the assessment scores is displayed on the user interface display 400. Each of the dial indicators 412 may include a dimension label 414 with a dimension-level score 416 associated with the dimension. The dial indicators 412 may also be color coded to indicate the level to which the particular dimension complies with industry best practices and generally serves as an indicator of the health of the application.

The color key 418 further describes the meaning of the color coding related to the competency-level score 408 and dimension-level score 416. For example, a color code of red indicates that the score is within a range from 0-60 and is considered as needing improvement. A color code of yellow indicates that the score is within a range from 61-79 and is considered as partially needing improvement to be fully compliant with the industry best practices. A color code of green indicates that the score is within a range from 80-100 and is considered fully compliant with industry best practices. A similar color coding method may be used to highlight the color of application-level scores and overall product level scores as well.

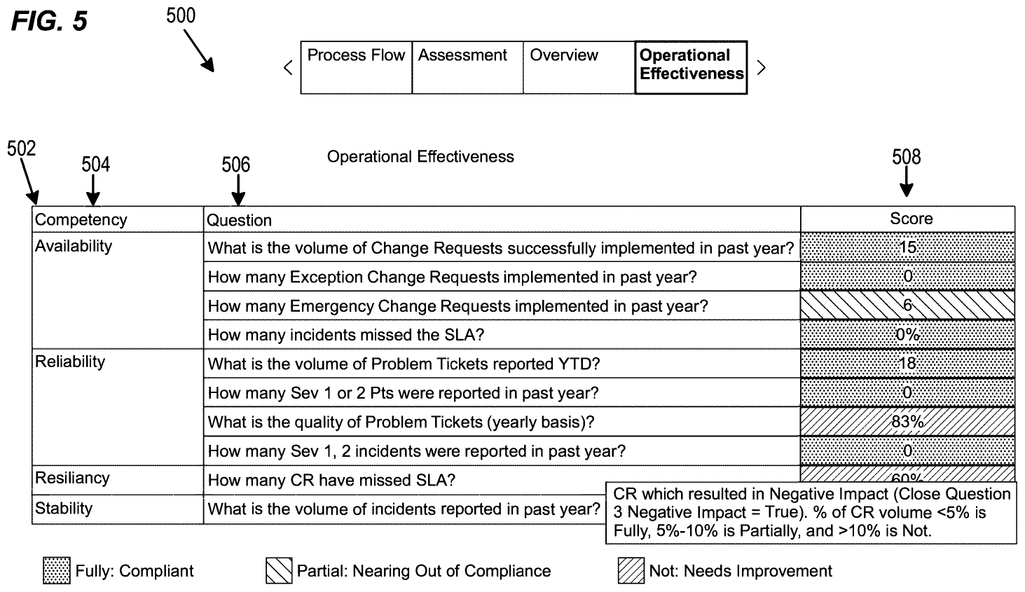

FIG. 5 illustrates another example user interface display 500 generated by the product resiliency and health assessment engine of FIG. 2. The user interface display 500 is configured to display a detailed view of a particular dimension. For example, the display may be triggered by a user selection of one of the dimensions from FIG. 4. In the example from FIG. 5, the dimension-level scoring of the “operational effectiveness” dimension is illustrated in further detail.

The user interface display 500 includes a spreadsheet 502 with several columns and rows. The columns are configured to display the competency name 504, one or more questions 506 associated with each of the competencies defined by the competency name 504, and a question-level score 508 associated with each of the questions 506. For example, in the example from FIG. 5, the spreadsheet 502 includes a first column that includes the following competency names 504: “availability,” “reliability,” “resiliency” and “stability.”

A second column of the spreadsheet 502 includes one or more questions 506 associated with each of the competencies defined by the competency name 504. Each of the one or more questions 506 are used to assess the competency defined by the competency name 504. For example, in FIG. 5, the “availability” competency is associated with four questions: “what is the volume of change requests successfully implemented in the past year?”, “how many exception change requests implemented in past year?”, “how many emergency change request implemented in past year?”, “how many incidents missed the SLA?”. Similarly, in FIG. 5, the “reliability” competency is associated with four questions, the “resiliency” competency is associated with one question and the “stability” competency is associated with one question.

A third column of the spreadsheet 502 includes a question-level score 508 corresponding to each of the one or more questions 506 in the second column. When a response to the question is determined to be “fully compliant,” the corresponding question-level score 508 may be assigned a score of 4 and given a color coding of green. When a response is determined to be “partially compliant,” the corresponding question-level score 508 may be assigned a score of 3 and given a color coding of yellow. When a response is determined to be “not compliant,” the corresponding question-level score 508 may be assigned a score of 1 and given a color coding of red.

As seen in FIG. 5, while the third column represents the question-level score 508, the cells of the third column may be populated by the responses to one or more questions 506 corresponding each of the cells. The scoring of the response may only be indicated by the color coding itself. In addition, hovering over or selecting a cell of the question-level score 508 cell may cause the display of a display box describing the response to the associated question along with how the response was evaluated in order to determine the question-level score for the cell.

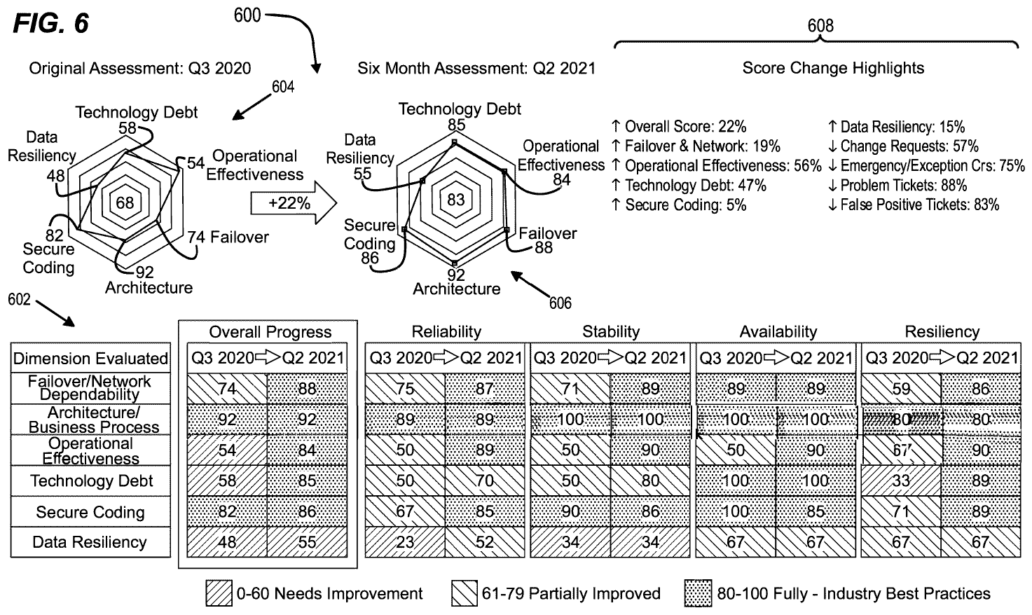

FIG. 6 illustrates yet another example user interface display 600 generated by the product resiliency and health assessment engine of FIG. 2. The user interface display 600 is configured to display the progression of the competency-level scores for each of the dimensions an application over a time period.

The user interface display 600 includes a grid 602 that includes columns associated with each of the competency criteria and rows associated with each of the multiple dimensions. Each column of the grid 602 represents each of the competency criteria and presents dimension-level scores along each row of the column. Thus, the grid 602 from FIG. 6 includes 5 columns, wherein four of the columns each represent each of the four different competency criteria with each of the rows within each of the columns representing the competency-level score associated with a particular dimension. The final column represents the overall progress, which includes the average dimension-level scores for each of the dimension across all of the competency criteria.

In addition, each of the columns of the grid 602 may be split into two different sub-columns wherein each of the sub-columns may be associated with one of the time periods. In the instant example from FIG. 6, the time periods represented in the sub-columns of the grid 602 are the third quarter in 2020 (Q3 2020) and the second quarter in 2021 (Q2 2021).

The user interface display 600 may also be configured to include a first spider-web chart 604 of the average dependency-level scores associated with application at a first time period (Q3 2020) and a second spider-web chart 606 of the average dependency-level scores associated with application at a second time period (Q2 2021). The first and second spider web-charts 604, 606 provide a simple summary of the average dimension-level scores with a central average application-level score for easy assessment of the resiliency and health of the application.

The user interface display 600 may also be configured to include a display of score change highlights 608 that provide a brief overview of the summary of changes in scores with arrows and percentage of change values for easy evaluation of the amount of change one or more of the scores have undergone during the time period over which the assessment is conducted.

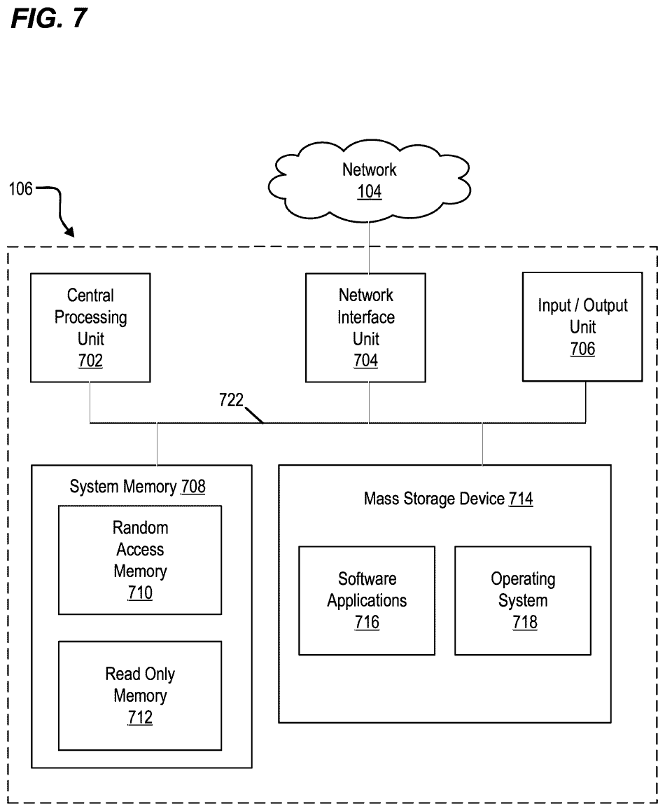

FIG. 7 illustrates example physical components of the computing devices of FIG. 1. As illustrated in the example of FIG. 7, the server computer 106 includes at least one central processing unit (“CPU”) 702, a system memory 708, and a system bus 722 that couples the system memory 708 to the CPU 702. The system memory 708 includes a random-access memory (“RAM”) 710 and a read-only memory (“ROM”) 712. A basic input/output system that contains the basic routines that help to transfer information between elements within the server computer 106, such as during startup, is stored in the ROM 712. The server computer 106 further includes a mass storage device 714. The mass storage device 714 is able to store software instructions and data associated with software applications 716. Some or all of the components of the server computer 106 can also be included in user electronic computing device 102.

The mass storage device 714 is connected to the CPU 702 through a mass storage controller (not shown) connected to the system bus 722. The mass storage device 714 and its associated computer-readable data storage media provide non-volatile, non-transitory storage for the server computer 106. Although the description of computer-readable data storage media contained herein refers to a mass storage device, such as a hard disk or solid-state disk, it should be appreciated by those skilled in the art that computer-readable data storage media can be any available non-transitory, physical device or article of manufacture from which the central processing unit can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the server computer 106.

According to various embodiments of the invention, the server computer 106 may operate in a networked environment using logical connections to remote network devices through the network 104, such as a wireless network, the Internet, or another type of network. The server computer 106 may connect to the network 104 through a network interface unit 704 connected to the system bus 722. It should be appreciated that the network interface unit 704 may also be utilized to connect to other types of networks and remote computing systems. The server computer 106 also includes an input/output controller 706 for receiving and processing input from a number of other devices, including a touch user interface display screen, or another type of input device. Similarly, the input/output controller 706 may provide output to a touch user interface display screen or other type of output device.

As mentioned briefly above, the mass storage device 714 and the RAM 710 of the server computer 106 can store software instructions and data associated with software applications 716. The software instructions include an operating system 718 suitable for controlling the operation of the server computer 106. The mass storage device 714 and/or the RAM 710 also store software instructions, that when executed by the CPU 702, cause the server computer 106 to provide the functionality of the server computer 106 discussed in this document. For example, the mass storage device 714 and/or the RAM 710 can store software instructions that, when executed by the CPU 702, cause the server computer 106 to display received data on the display screen of the server computer 106.

Although various embodiments are described herein, those of ordinary skill in the art will understand that many modifications may be made thereto within the scope of the present disclosure. Accordingly, it is not intended that the scope of the disclosure in any way be limited by the examples provided.

1. A method to assess a health of a product, the method comprising:
receiving one or more applications to assess the health of the product, wherein each of the one or more applications is assessed based on multiple dimensions;
retrieving data related to the multiple dimensions associated with each of the one or more applications from one or more data sources;
retrieving one or more assessment criteria to assess the multiple dimensions associated with each of the one or more applications;
providing responses to the one or more assessment criteria based on the data;
assigning scores to the responses to the one or more assessment criteria;
based on the scores, calculating an overall health score for the product; and
generating a user interface for display on a user electronic computing device, wherein the user interface includes:
a display of the overall health score as calculated during a current assessment period, and a display of a previous overall health score as calculated during a previous assessment period, with the display of the overall health score and the display of the previous overall health score including one or more visual elements to denote a level of health indicated by the overall health score and the previous overall health score; and
a score change highlights section that includes a summary of changes between the overall health score and the previous overall health score, including a percentage of change between the overall health score and the previous overall health score and a graphical element to denote whether the overall health score has increased or decreased since the previous overall health score.

2. The method of claim 1, further comprising assigning weights to the one or more applications based on one or more criticality factors.

3. The method of claim 2, wherein the one or more criticality factors include: a level of importance of the product to an organization; whether the product is customer facing; whether the product has historically had health or resiliency issues; a level of impact a compromise to the product would have to the organization; and whether the product is soon to be released.

4. The method of claim 2, wherein calculating the overall health score for the product includes:
calculating a dimension-level score for the multiple dimensions of the one or more applications by averaging the scores associated with the one or more assessment criteria for each of the multiple dimensions;
calculating an application-level score for the one or more applications associated with the product by averaging the dimension-level score associated with each of the multiple dimensions associated with each of the one or more applications; and
calculating the overall health score by calculating a weighted average score based on the weights of the each of the one or more applications and the application-level score of each of the one or more applications.

5. The method of claim 4, wherein the user interface further includes the application-level score for each of the one or more applications of the product and the dimension-level score for each of the multiple dimensions for each of the one or more applications of the product.

6. The method of claim 4, wherein to assess each of the multiple dimensions further includes assessing one or more competency criteria associated with each of the multiple dimensions.

7. The method of claim 6, wherein assessing the one or more competency criteria associated with each of the multiple dimensions includes assessing one or more of: availability, reliability, resiliency, and stability of each of the multiple dimensions.

8. The method of claim 6, wherein calculating the dimension-level score for each of the one or more applications further includes calculating a competency-level score for each of the one or more competency criteria associated with each of the multiple dimensions.

9. The method of claim 8, wherein the user interface further includes the competency-level score for each of the one or more competency criteria associated with each of the multiple dimensions for each of the one or more applications of the product.

10. The method of claim 8, wherein the dimension-level score for each of the multiple dimensions of each of the one or more applications is displayed as a dial indicator on the user interface and the competency-level score for each of the one or more competency criteria associated with the multiple dimensions is displayed within a grid on the user interface.

11. The method of claim 1, wherein the one or more visual elements includes highlighting the overall heath score in green when the overall health score is higher than a first threshold score, highlighting the overall health score in yellow when the overall health scores is higher than a second threshold and lower than the first threshold score and highlighting the overall health score in red when the overall health score is lower than the second threshold.

12. The method of claim 1, wherein the multiple dimensions include two or more of: data resiliency, security assessment, technology debt, operations performance, business process, failover and technology governance and compliance.

13. A product health assessment system comprising:
a processor; and
memory comprising instructions that when executed by the processor causes the processor to:
receive one or more applications to assess a health of the product, wherein each of the one or more applications is assessed based on multiple dimensions;
retrieve data related to the multiple dimensions associated with each of the one or more applications from one or more data sources;
retrieve one or more assessment criteria to assess each of the multiple dimensions associated with each of the one or more applications;
provide responses to each of the one or more assessment criteria based on the data;
assign scores to the responses to each of the one or more assessment criteria;
based on the scores, calculate an overall health score for the product; and
generate a user interface for display on a user electronic computing device, wherein the user interface includes:
a display of the overall health score as calculated during a current assessment period, a display of a previous overall health score as calculated during a previous assessment period, with the display of the overall health score and the display of the previous overall health score including one or more visual elements to denote a level of health indicated by the overall health score and the previous overall health score; and
a score change highlights section that includes a summary of changes between the overall health score and the previous overall health score, including a percentage of change between the overall health score and the previous overall health score and a graphical element to denote whether the overall health score has increased or decreased since the previous overall health score.

14. The product health assessment system of claim 13, wherein the instructions when executed by the processor further cause the processor to assign weights to the one or more applications based on one or more criticality factors.

15. The product health assessment system of claim 14, wherein calculating the overall health score for the product includes:
calculating a dimension-level score for each of the multiple dimensions of each of the one or more applications by averaging the scores associated with the one or more assessment criteria for each of the multiple dimensions;
calculating an application-level score for each of the one or more applications associated with the product by averaging the dimension-level score associated with each of the multiple dimensions associated with each of the one or more applications; and
calculating the overall health score by calculating a weighted average score based on the weights of the each of the one or more applications and the application-level score of each of the one or more applications.

16. The product health assessment system of claim 15, wherein the user interface further includes the application-level score for each of the one or more applications of the product and the dimension-level score for each of the multiple dimensions for each of the one or more applications of the product.

17. The product health assessment system of claim 16, wherein the dimension-level score for each of the multiple dimensions of each of the one or more applications is displayed as a dial indicator on the user interface.

18. The product health assessment system of claim 13, wherein the one or more visual elements includes highlighting the overall heath score in green when the overall health score is higher than a first threshold score, highlighting the overall health score in yellow when the overall health scores is higher than a second threshold and lower than the first threshold score and highlighting the overall health score in red when the overall health score is lower than the second threshold.

19. The product health assessment system of claim 13, wherein the multiple dimensions include two or more of: data resiliency, security assessment, technology debt, operations performance, business process, failover and technology governance and compliance.

20. A method to assess a health of a product, the method comprising:
receiving one or more applications associated with the product;
retrieving data related to multiple dimensions associated with each of the one or more applications from one or more data sources;
retrieving one or more assessment criteria to assess each of the multiple dimensions associated with each of the one or more applications;
providing responses to each of the one or more assessment criteria based on the data;
assigning scores to the responses to each of the one or more assessment criteria;
based on the scores, calculating an overall health score for the product by:
calculating a dimension-level score for each of the multiple dimensions of each of the one or more applications by averaging the scores associated with the one or more assessment criteria for each of the multiple dimensions;
calculating an application-level score for each of the one or more applications associated with the product by averaging the dimension-level score associated with each of the multiple dimensions associated with each of the one or more applications; and
calculating the overall health score by calculating a weighted average score based on the weights of the each of the one or more applications and the application-level score of each of the one or more applications; and
generating a user interface for display on a user electronic computing device, wherein the user interface includes:
the overall health score of the product, the application-level score for each of the one or more applications associated with the product, and the dimension-level score for each of the multiple dimensions of each of the one or more applications as calculated during a current assessment period;
a previous overall health score of the product, a previous application-level score for each of the one or more applications associated with the product, and a previous dimension-level score for each of the multiple dimensions of each of the one or more applications as calculated during a previous assessment period; and
a score change highlights section that includes a summary of changes between the overall health score and the previous overall health score, including a percentage of change between the overall health score and the previous overall health score and a graphical element to denote whether the overall health score has increased or decreased since the previous overall health score;
wherein the overall health score, the application-level score, the dimension-level score, the previous overall health score, the previous application-level score and the previous dimension-level score are color coded to visually indicate a level of health.
